(19) United States
(12) Patent Application Publication
(10) Pub. No.: US 2019/0220861 A1
(43) Pub. Date: Jul. 18, 2019

(54) VEHICLE TRACKING, ANALYSIS AND PAYMENT OF PROCESSING SYSTEM AND METHOD USING A DISTRIBUTED LEDGER

(71) Applicant: Overstock.com, Inc., Midvale, UT (US)

(72) Inventors: Jason Silver, Midvale, UT (US); Vikram Raghavan, Midvale, UT (US)

(21) Appl. No.: 16/247,389

(22) Filed: Jan. 14, 2019

Related U.S. Application Data
(60) Provisional application No. 62/617,026, filed on Jan. 12, 2018.

(51) Int. Cl. G06Q 20/40; H04L 9/32; G06Q 40/08; G06Q 20/36

(52) U.S. Cl. CPC G06Q 20/401; H04L 9/3213; G06Q 2220/00; G06Q 20/367; G06Q 40/08

(57) ABSTRACT

The system described herein can generate a vehicle token identified by the vehicle's vehicle identification number (VIN) upon manufacture of a vehicle and record the creation of the vehicle token on a distributed ledger. Throughout the life of the vehicle, the vehicle token can be updated with information regarding the vehicle (e.g., maintenance records, accidents, upgrades, owners, locations) and such information can be recorded on the distributed ledger. The system can mine and analyze the information recorded on the distributed ledger to determine a valuation or score of the vehicle, to advertise, and to connect potential buyers and sellers.

### CROSS-REFERENCE TO RELATED APPLICATIONS

This application is a non-provisional of and claims priority to U.S. Provisional Application No. 62/617,026, filed on Jan. 12, 2018, entitled “VEHICLE TRACKING, ANALYSIS AND PAYMENT PROCESSING SYSTEM AND METHOD USING A DISTRIBUTED LEDGER,” which is hereby incorporated by reference in its entirety for all purposes.

### TECHNICAL FIELD

Various embodiments of the present disclosure generally relate to vehicle transactions and records. More specifically, various embodiments of the present disclosure relate to systems and methods of vehicle tracking, analysis and payment processing using distributed ledger.

### BRIEF DESCRIPTION OF THE DRAWINGS

Embodiments of the present disclosure will be described and explained through the use of the accompanying drawings in which:

FIG. 1 illustrates an example of a network-based operating environment in accordance with various embodiments of the disclosure;

FIG. 2 illustrates a set of components in a vehicle tracking, analysis and payment platform according to one or more embodiments of the present disclosure;

FIG. 3 illustrates a process of tracking and analyzing vehicle records in accordance with one or more embodiments of the present disclosure; and

FIG. 4 illustrates an example of a computer system with which some embodiments of the present disclosure may be utilized.

### DETAILED DESCRIPTION

Vehicle information such as mileage, condition, owners, and repair and maintenance can change frequently. These factors, among many others, determine the value of a vehicle. Prior systems do not provide a viable way to record, update and maintain vehicle information records which makes it difficult for potential buyers to assess the true value of a vehicle.

Additionally, current systems pay and settle payments to vehicle service providers in an inefficient manner. For example, when a vehicle is serviced by a service shop, the owner or an insurance company pays a fee to the repair or service shop, who in turn pays a parts supplier for parts, who in turn pays a fee to various parties, etc. Between each of these transactions, there is a delay period (e.g., deposit a check, write another check), not to mention the additional transaction costs. Embodiments of the present disclosure disclose a vehicle tracking, analysis and payment system that maintains a record of vehicle information and analyzes the information, as well as allocates funds immediately to various parties without requiring the traditional deposit, wait-and-pay process for payment to multiple parties.

In various embodiments, a vehicle token identified by the vehicle's vehicle identification number (VIN) can be created upon manufacture of a vehicle and recorded on a distributed ledger. The vehicle token can be an asset-backed token such that the owner of the token owns the vehicle. In other embodiments, the vehicle token is an identity record of the vehicle and while the identity record can be owned by the owner of the vehicle, the owner of the vehicle token is not necessarily the owner of the vehicle. Throughout the life of the vehicle, the vehicle token can be updated with information regarding the vehicle (e.g., maintenance records, accidents, upgrades, owners, locations) and such information can be recorded on a distributed ledger. The system can mine and analyze the information recorded on the distributed ledger to determine a valuation or score of the vehicle, to advertise various parts and services that may be of interest to vehicle owners, and to connect potential buyers and sellers. In some embodiments, a website or mobile application may be used to write to or retrieve information from the distributed ledger, including the vehicle information and owner information. In some embodiments, a user can use the information in the distributed ledger to validate a driver's license, ensure that insurance information is valid and bind contracts.

In some embodiments, the system, a vehicle owner, insurance company or other entity can create a fund token associated with the vehicle token. The fund token can be transferred in whole or in part in exchange for parts or services related to the vehicle. In some embodiments, after a service provider updates or requests an update to the vehicle token to record maintenance or repair work on the vehicle, the system can process a transaction to transfer the fund token to the appropriate party or parties.

The vehicle tokens and the fund tokens can be updated with additional information and/or transferred to other owners using cryptographic techniques such as public-key cryptography and bidirectional encryption. Public-key cryptography requires a key pair, where the two keys are mathematically linked. One key is a public key that is freely shared among nodes in a peer-to-peer network. The other key is a private key that is not shared with the public. The public key is used to encrypt plaintext and to verify a digital signature. The private key is used to decrypt cipher text and to digitally sign transactions. Transaction messages may be digitally signed by the sender's private key to authenticate the sender's identity. Then, the sender's digitally-signed transaction message may be decrypted using the sender's public key to verify that the sender originated the transaction. In some embodiments, the fund token and the vehicle token are owned by the same party (e.g., vehicle owner) and associated with the same key pair (i.e., addressed account).

Ownership of fund tokens and vehicle tokens may be based on ownership entries in distributed ledgers that are maintained by network nodes. The distributed ledgers (e.g., blockchain for Bitcoin) record entries for each change of ownership and each bit of additional information of each token or other digital transactional item and may be mathematically linked to the key pairs. For example, if an insurance company (on behalf of a vehicle owner) was to pay a repair shop using a fund token, a transaction message (e.g., in packets or other data structures) may be broadcast to nodes on a peer-to-peer network. The transaction message can be signed by the vehicle owner's (or the insurance company's) private key and can include the repair shop's public key-based address. When a majority of the nodes in the network agree that the vehicle owner or the insurance company has the proper chain of title, ownership of the fund token or a portion of the fund token is changed to the repair shop and the distributed ledger is updated to indicate the transaction. Other consensus mechanisms can be used (e.g., proof of stake, proof of authority).

In an example, when a payment request is received by the vehicle tracking analysis and payment platform (e.g., a service provider has completed a service and has indicated such by updating the record associated with the vehicle token), the vehicle tracking, analysis and payment platform can create a cryptographic transaction transferring the fund token (or a portion of the fund token) to the service provider and the transfer can be recorded to a distributed ledger.

Benefits of storing vehicle information on a distributed ledger include having a complete, immutable record of the vehicle's history. Also, particularly where the vehicle token is asset-backed or where the vehicle token is owned by the owner of the vehicle, prospective buyers of the vehicle can have a record of the vehicle's origin and history of transfers. Having provenance that traces the vehicle back to its manufacture, along with its history of maintenance gives potential buyers confidence about where the vehicle originated and how it has been maintained. Although this disclosure primarily discusses vehicles, the techniques described herein can be used for payment processing, record tracking and analysis for other assets such as a home or a security.

Vehicle owners and services providers have incentives to ensure information is recorded on the distributed ledger. To maximize the value of the vehicle, a vehicle owner is incentivized to keep maintenance records and warranty information up to date. Manufacturers are incentivized to participate to track customers, sell future products, ensure recall notifications, contact the vehicle owner, and keep resale values high. Service stations are incentivized to participate because not participating may devalue the resale of a vehicle and decrease business. Participating service stations can advertise their participation and gain additional customers. Participating parts providers can have their purchases connected with the owner's vehicle and can be listed on any applications. Insurance providers and aftermarket service contract providers can use the information in the distributed ledger to determine risk and to market to select customers.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Where context permits, words using the singular or plural form may also include the plural or singular form, respectively, and for the sake of brevity are not distinguished in the text.

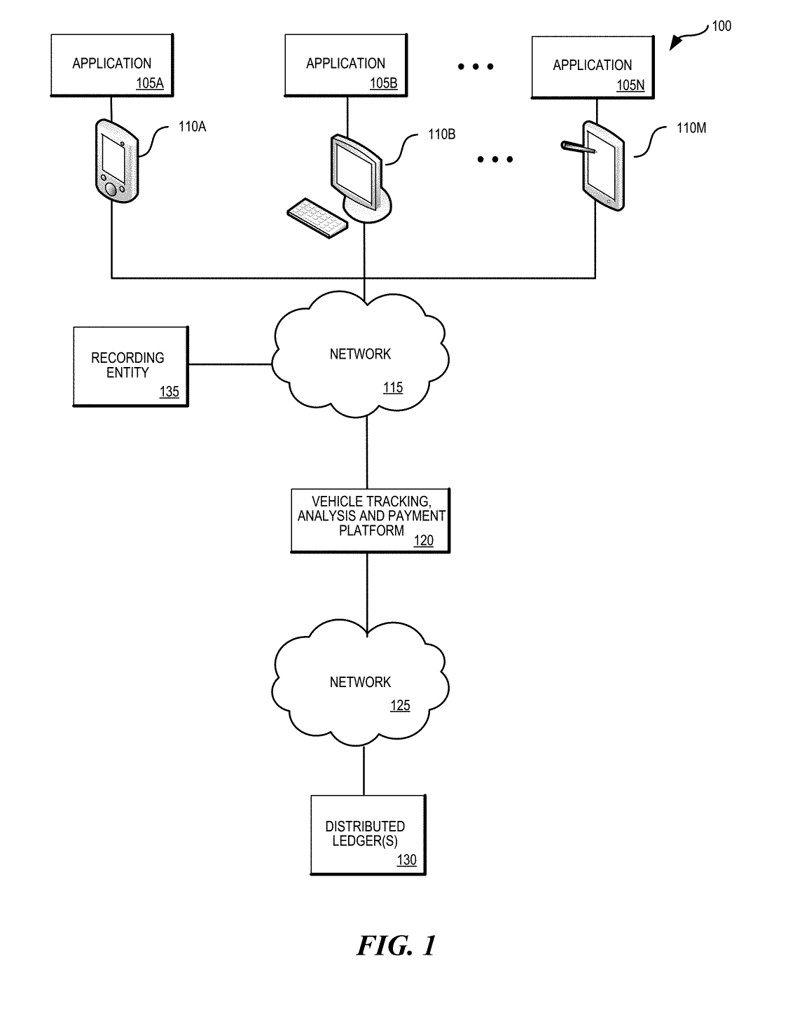

FIG. 1 illustrates an example of a network-based operating environment 100 in which some embodiments of the present disclosure may be used. As illustrated in FIG. 1, operating environment 100 includes applications 105A-105N running on one or more computing devices 110A-110M (such as a mobile device, a mobile phone, a tablet computer, a mobile media device, a mobile gaming device, a vehicle-based computer, a dedicated terminal, a public terminal, desktop, or laptop computer, a kiosk, etc.). In some embodiments, applications 105A-105N for carrying out operations such as generating and updating vehicle tokens and transferring fund tokens may be stored on the computing devices or may be stored remotely. These computing devices can include mechanisms for receiving and sending traffic by connecting through network 115 to vehicle tracking, analysis and payment platform 120.

Computing devices 110A-110M are configured to communicate via network 115 with vehicle tracking, analysis and payment platform 120. In some embodiments, computing devices 110A-110M can retrieve or submit information to vehicle tracking, analysis and payment platform 120 and run one or more applications with customized content retrieved by vehicle tracking, analysis and payment platform 120 and broker-dealer 115. For example, computing devices 110A-110M each can execute a browser application or a customized client to enable interaction between the computing devices 110A-110M and the vehicle tracking, analysis and payment platform 120.

Recording entity 135 is an entity (i.e., natural person, company) that engages in the business of tracking vehicles for its own account or on behalf of the owners of vehicle tokens (typically vehicle owners). In some embodiments, recording entity 135 manages various permissions so that entities can create transactions to update the vehicle token. In other embodiments, recording entity 135 creates or requests transactions to update vehicle tokens when transactions or transaction requests are received from an entity (e.g., service shop, DMV) via computing devices 110A-110M. Recording entity 135 can communicate transactions to the vehicle tracking, analysis and payment platform 120 via network 115. Each recording entity can act on behalf of the vehicle owner by using the vehicle owner's key pair to initiate transactions.

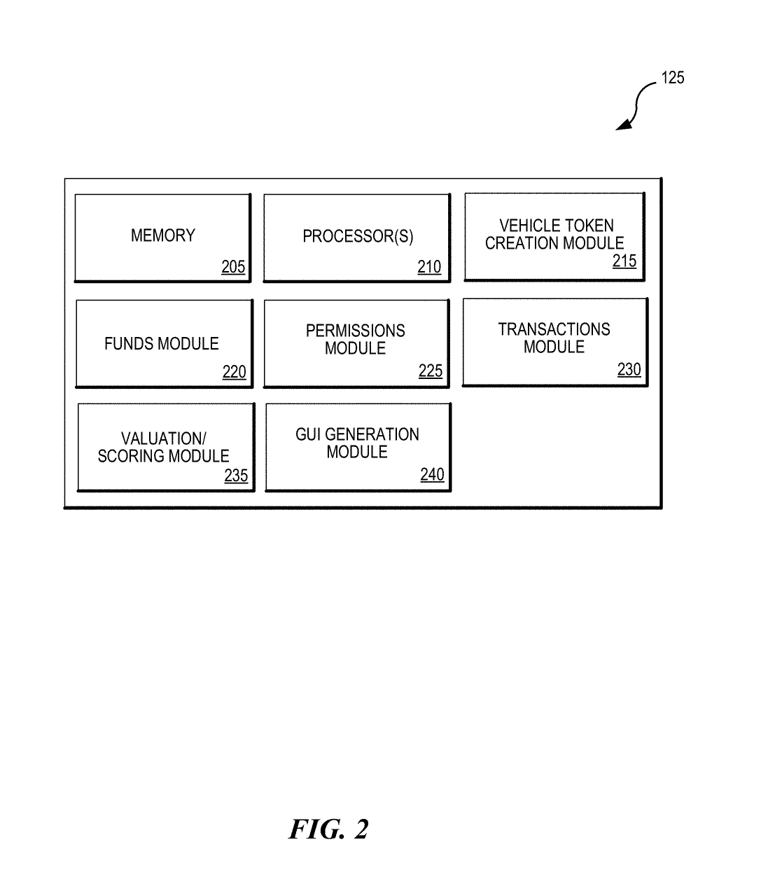

The vehicle tracking, analysis and payment platform 120 can run on one or more servers and can be used to track vehicle records, analyze the records and provide payments to service providers. In some embodiments, and as illustrated in FIG. 2, the vehicle tracking, analysis and payment platform 120 includes vehicle token creation module 215, funds module 220, permissions module 225, transactions module 230, valuation/scoring module 235, and graphical user interface (GUI) generation module 240. The vehicle tracking, analysis and payment platform 120 is communicably coupled with one or more distributed ledger(s) 130 through network 125.

Network 115 and network 125 can be the same network or can be separate networks and can be any combination of local area and/or wide area networks, using wired and/or wireless communication systems. Either network 115 or network 125 could be or could use any or more protocols/technologies: Ethernet, IEEE 802.11 or Wi-Fi, worldwide interoperability for microwave access (WiMAX), cellular telecommunication (e.g., 3G, 4G, 5G), CDMA, cable, digital subscriber line (DSL), etc. Similarly, the networking protocols used on network 115 and network 125 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 and network 125 may be represented using technologies, languages and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

Distributed ledger(s) 130 includes various tokens such as vehicle tokens and fund tokens. In some embodiments, the vehicle tokens can be asset-backed tokens and/or can be an identity record of the vehicle that includes information about the vehicle and the owner. In some embodiments, the vehicle token can further include one or more valuations or scores of the vehicle based on the information associated with the vehicle token. Fund tokens can be an asset-backed token representing a financial instrument such as currency. In other embodiments, fund tokens are digital currency such as cryptocurrency (e.g., Bitcoin).

Distributed ledger(s) 130 can be used to record transaction such as updates to the vehicle token and to transfer the vehicle token or fund token. When distributed ledger(s) 130 receives a transaction signed with the proper key from vehicle tracking, analysis and payment platform 120 and the transaction is verified by network nodes, distributed ledger 130 can update the vehicle token or transfer the vehicle token or one or more fund tokens to a different owner by associating the token with a different addressed account and recording the transaction (e.g., securing a transaction in a block to the blockchain).

Various data stores can be used to manage storage and access to digital securities, user information, and other data. The data stores may be distributed data stores such as distributed ledger(s) 130. The data stores may be a data repository of a set of integrated objects that are modeled using classes defined in database schemas. Data stores may further include flat files that can store data. Vehicle tracking, analysis and payment platform 120 and/or other servers may collect and/or access data from the data stores.

FIG. 2 illustrates a set of components within vehicle tracking, analysis and payment platform 120 according to one or more embodiments of the present disclosure. According to the embodiments shown in FIG. 2, vehicle tracking, analysis and payment platform 120 can include memory 205, one or more processor(s) 210, vehicle token creation module 215, funds module 220, permissions module 225, transactions module 230, valuation/scoring module 235, and GUI generation module 240. Other embodiments may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, permissions module 225 and transactions module 230 can be combined into a single component.

Memory 205 can be any device, mechanism, or populated data structure used for storing information. In accordance with some embodiments of the present disclosure, memory 205 can be or include, for example, any type of volatile memory, nonvolatile memory, and dynamic memory. For example, memory 205 can be random access memory, memory storage devices, optical memory devices, magnetic media, floppy disks, magnetic tapes, hard drives, erasable programmable read-only memories (EPROMs), electrically erasable programmable read-only memories (EEPROMs), compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of vehicle token creation module 215, funds module 220, permissions module 225, transactions module 230, valuation/scoring module 235, and GUI generation module 240.

Vehicle token creation module 215 creates a vehicle token, preferably upon manufacture, and stores it on a distributed ledger. The vehicle token is typically owned by the owner of the vehicle. The vehicle token can be an asset backed token meaning that title of the vehicle transfers with the token and/or the vehicle token can be an identity record in which ownership of the vehicle token has no bearing on the title of the vehicle. The vehicle token can be identified by the vehicle's VIN and can include information about the vehicle such as make, model, owner, maintenance history, warranties, a length of warranty remaining, interior and exterior color, owner information (e.g., driver's license, insurance, address), certain parts (e.g., type of airbags), cost estimates for damage repair, maintenance records including an identity of who performed the work and from where parts were sourced, receipts for work done, recommended work, accident and police reports, insurance reports, transaction history such as parties and sale price, mileage, age of drivers, videos, virtual reality videos, pictures, real-time data gathered from the vehicle, lease agreements, locations of the vehicle, registration information and other DMV information, and fuel type. In some embodiments, the vehicle token can further include a valuation or score of the vehicle at any moment in time as created by valuation/scoring module 235 based on the information associated with the vehicle token. Sensitive information can be encrypted but otherwise the vehicle information associated with the vehicle token can be publicly available via the distributed ledger. In some embodiments, a user can certify whether damages occurred if a third party does not report damages.

Funds module 220 can create fund tokens which are asset-backed tokens representing a financial instrument (e.g., cash or other currency, check). In some embodiments, the fund tokens are associated with vehicle tokens. The fund tokens can be owned by the owner of the vehicle and can be used to pay service providers who service the vehicle associated with the vehicle token. In some embodiments, funds are not distributed until the service provider updates the vehicle token with the service record or takes some other action in accordance with a smart contract.

In an example, if a vehicle is in an accident and is being repaired, the insurance company can create a fund token to pay for the services and can directly transfer the fund token(s) or part of a fund token to the service provider or can transfer the fund token to the vehicle owner (in which case the insurance company or recording entity can act on behalf of the vehicle owner and transfer the token or part of the token to the service provider from the vehicle owner's addressed account or the vehicle owner can transfer the token or part of the token the service provider).

Using fund tokens in exchange for services can make payment processes more efficient by eliminating the need for issuing checks, making withdrawals, re-issuing checks, etc. For example, typically when a car receives service, parts are ordered, the repairs are completed, and the insurance company issues a check either to the vehicle owner or the repair shop. The repair shop deposits the check and writes a new check to the parts supplier and other providers. To expedite the payment process, the insurance company can issue a fund token (e.g., backed by dollars) and can pay each party directly as needed (or when a record associated with the vehicle token is updated) by transferring fund tokens. Or, the insurance company can issue a fund token and immediately transfer the fund token to the repair shop. In turn, the repair shop can transfer a portion of the fund token to other service or parts providers. In some embodiments, an insurance company can provide one or more fund tokens for several repairs at one time for different vehicles. The repair shop can redeem currency in exchange for the fund token or can keep the fund token.

Permissions module 225 can obtain instructions from the owner of the vehicle token and/or the fund token specifying who has authorization to perform transactions and can provide parties with the required information. “Transactions” can include updating the vehicle token with information (e.g., maintenance record), transferring the vehicle token to a different person or entity, and transferring the fund token, all recorded to a distributed ledger. A transaction can require a permission from the owner of the applicable token (e.g., private key). The owner of the applicable token can provide such permission to various parties, allowing the various parties to transact on his/her behalf. This alleviates the need for the owner to provide all the updates throughout the lifecycle of the vehicle.

In some embodiments, in creating a vehicle token, the owner automatically provides certain entities permission to update the vehicle token. For example, government agencies and insurance companies automatically may be granted permission to update the vehicle record to prevent vehicle owners from trying to hide information that could be damaging to their vehicle's value. In other embodiments, one system such as vehicle tracking, analysis and payment platform acts on behalf of the owner of the vehicle token by obtaining the public and private key set (with permission), receiving all vehicle updates from all parties, and recording the updates to the distributed ledger using the public and private key set. In some embodiments, the distributed ledger is private in that only certain entities can read or write to the distributed ledger.

Transactions module 230 sends a request to perform a transaction. Assuming the transaction is a transaction to update the vehicle token, the transaction request may include the private key and the public key associated with the vehicle token along with the information to be added. Once the network nodes agree that the transaction is valid, the vehicle token is updated and recorded on the distributed ledger, creating an immutable record. Entities who may request a transaction include vehicle owners, insurance companies, repair shops, parts suppliers, government agencies such as the DMV, auctions, dealerships, car wash providers, and gas stations. But, any entity updating any record is required to have the proper credentials to update the record. In some embodiments, transaction requests are received from devices on the vehicle. For example, real-time or periodic data can be provided to transactions module 230 with information such as mileage, real-time speed, average speed, terrain, and real-time gas mileage, and average gas mileage. In some embodiments, such information is collected and recorded to the distributed ledger on a periodic basis (e.g., every six months) or if a certain parameter is exceeded (e.g., airbags deploy, certain speed exceeded, too many pounds being towed).

Valuation/scoring module 235 can mine through the vehicle information available on the distributed ledger and create a score or a valuation of the vehicle based on this information and other information. For example, based on the desirability of the vehicle in the particular area, the maintenance records, mileage, average speed driven, number of owners, warranty, and other factors, the vehicle can receive a score of 80 out of 100, resulting in a valuation of $15,667 for a private party sale. Each factor can be weighted differently, and many different scores can be created. The scores can be letters, numbers, colors, a combination of letters, numbers, and colors, or other symbols. In some embodiments, categorical sub-scores are created (e.g., maintenance sub-score, desirability sub-score) and used to generate the overarching score. The sub-scores can help potential buyers find a vehicle that meets their desires (e.g., potential buyer cares about maintenance but not year of vehicle).

Additionally, valuation/scoring module 235 can advertise the scores or valuations of vehicles and connect potential buyers and sellers. In some embodiments, valuation/scoring module 235 can bring an offer to a vehicle owner unsolicited. Valuation/scoring module 235 can analyze information on the distributed ledger such as maintenance records and determine whether a vehicle owner could benefit from different products (e.g., a new air filter, oil) or services (e.g., a different insurance plan).

GUI generation module 240 is capable of generating one or more GUI screens that allow interaction with a user. In at least one embodiment, GUI generation module 240 generates a graphical user interface receiving information from and/or conveying information to the user. For example, GUI generation module 240 may display an interface to assist a user with creating a vehicle token. Additionally GUI generation module 240 may display mechanics or repair shops who accept fund tokens, recommendations on insurance providers, possible buyers, valuations of the vehicle, advertisements for parts or services, and a history of transactions associated with a vehicle token.

Those skilled in the art will appreciate that the components illustrated in FIGS. 1-2 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

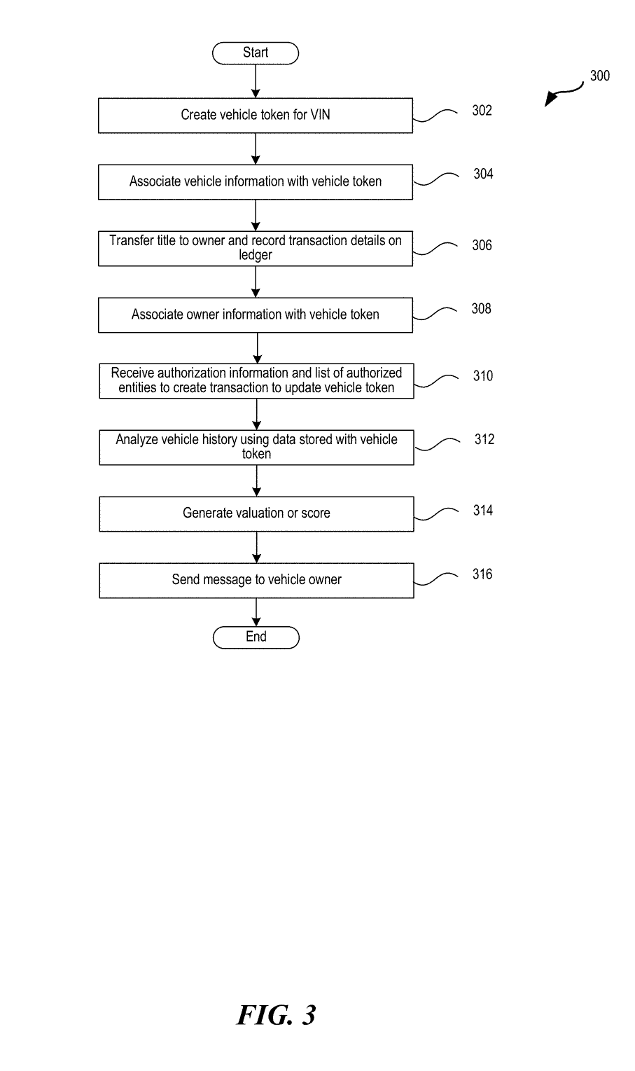

FIG. 3 illustrates a process of tracking and analyzing vehicle records. Creating operation 302 creates a vehicle token for a particular vehicle and records the vehicle token as identified by the vehicle's VIN on a distributed ledger. Associating operation 304 associates the vehicle information such as color, make, model, interior, and MSRP and records the features on the distributed ledger. Preferably, the vehicle token is created and vehicle information is associated with the vehicle token upon manufacture so an accurate record is created from the beginning of the life the vehicle. After a user purchases the vehicle, transferring operation 306 transfers the vehicle token to the new owner. The transaction details (e.g., location, price, add-ons) and the new owner information is recorded on the distributed ledger in associating operation 308. The new owner information can include driver's license, address, driving record, age, and registration details and can be obtained from the DMV, dealership, new owner, or other entity. Certain information, particularly private information, can be encrypted so that the information is not viewable by others.

Receiving operation 310 receives authorization information and a list of entities authorized to create transactions to update the vehicle token. Authorization information may include the owner's key pair and the list of entities can include service shops, insurance companies, government agencies, manufacturers, or other entities. The vehicle token can be updated by one entity receiving input from various entities (e.g., a recording entity) or a number of different authorized entities. Each time the vehicle token is requested to be updated, the network of nodes must agree that the transaction is authorized and build a new block (or otherwise update the record). Previous transactions cannot be altered. Analyzing operation 312 analyzes vehicle history using data stored with the vehicle token and generating operation 314 calculates a score and/or a valuation of the vehicle. Sending operation 316 sends a message regarding the vehicle's score to the owner of the vehicle.

### COMPUTER SYSTEM OVERVIEW

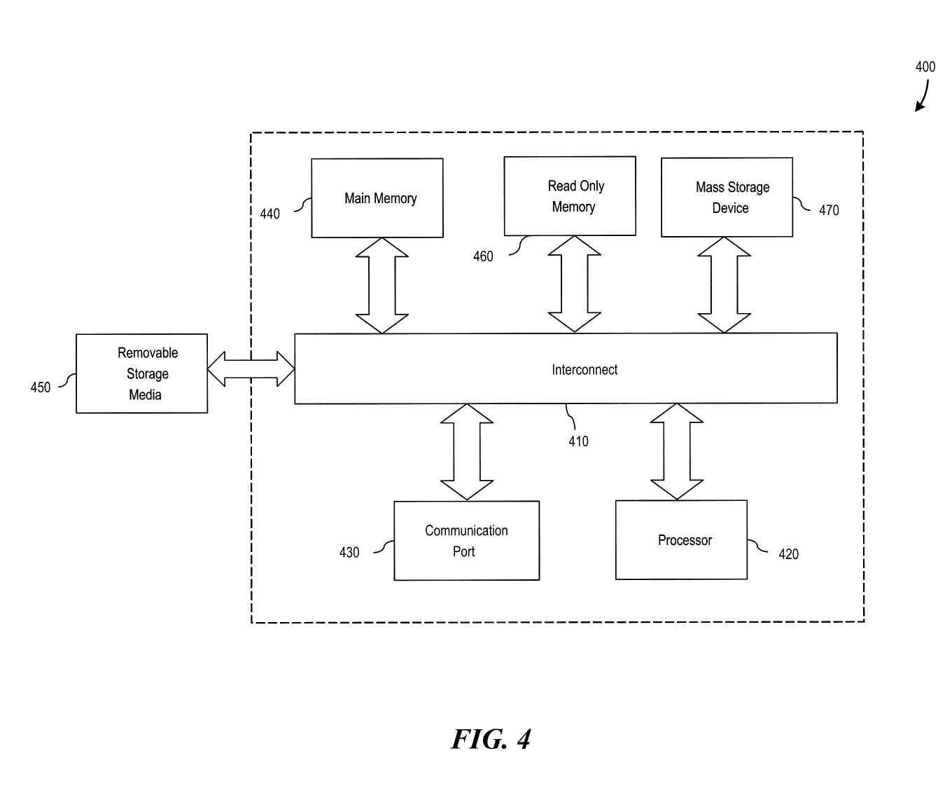

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 4 is an example of a computer system 400 with which embodiments of the present disclosure may be utilized. According to the present example, the computer system 400 includes an interconnect 410, at least one processor 420, at least one communication port 430, a main memory 440, a removable storage media 450, a read only memory 460, and a mass storage device 470.

Processor 420 can be any known processor. Communication port 430 can be or include, for example, any of an RS-232 port for use with a modem-based dialup connection, a 10/100 Ethernet port, or a Gigabit port using copper or fiber. The nature of communication port 430 may be chosen depending on a network such a Local Area Network (LAN), Wide Area Network (WAN), or any network to which the computer system 400 connects.

Main memory 440 can be Random Access Memory (RAM), or any other dynamic storage device commonly known in the art. Read only memory 460 can be any static storage device such as Programmable Read Only Memory (PROM) chips for storing static information such as instructions for processor 420.

Mass storage device 470 can be used to store information and instructions. For example, hard disks such as the Adaptec® family of SCSI drives, an optical disc, an array of disks such as RAID, such as the Adaptec family of RAID drives, or any other mass storage devices may be used.

Interconnect 410 can be or include one or more buses, bridges, controllers, adapters, and/or point-to-point connections. Interconnect 410 communicatively couples processor 420 with the other memory, storage, and communication blocks. Interconnect 410 can be a PCI/PCI-X or SCSI based system bus depending on the storage devices used.

Removable storage media 450 can be any kind of external hard-drives, floppy drives, Compact Disc-Read-Only Memory (CD-ROM), Compact Disc-Re-Writable (CD-RW), Digital Video Disc-Read-Only Memory (DVD-ROM).

The components described above are meant to exemplify some types of possibilities. In no way should the aforementioned examples limit the disclosure, as they are only exemplary embodiments.

### TERMINOLOGY

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

In conclusion, the present disclosure provides novel systems, methods, and arrangements for tracking and analyzing vehicle data and processing vehicle-related payments. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

What is claimed is:

1. A computerized method comprising:
creating, by a processor, a vehicle token for a vehicle upon manufacture,
wherein the vehicle token includes a vehicle identification number and information relating to the vehicle,
wherein the owner of the vehicle token owns the vehicle;
in response to a purchase of the vehicle by a user, cryptographically transferring the vehicle token to the user in a first transaction;
receiving, from sensors on the vehicle, a request for a second transaction, wherein the second transaction includes updating the information relating to the vehicle with information from the sensors; and
generating, based on the information relating to the vehicle, a valuation of the vehicle.

2. The computerized method of claim 1, further comprising recording the vehicle token, the first transaction, the second transaction, and the valuation to a distributed ledger.

3. The computerized method of claim 1, further comprising:
receiving, from an entity, a request for a third transaction relating to the vehicle, wherein the entity is a service provider servicing the vehicle; and
updating the information relating to the vehicle with information from the service provider.

4. The computerized method of claim 1, further comprising:
obtaining information relating to the owner of the vehicle; and
associating the information relating to the owner of the vehicle with the vehicle token.

5. The computerized method of claim 4, wherein the information relating to the owner of the vehicle is not publicly available.

6. The computerized method of claim 1, further comprising creating one or more fund tokens related to the vehicle token, wherein the one or more fund tokens are funded by an insurance company, wherein the one or more fund tokens pays service providers providing service to the vehicle.

7. A non-transitory, computer-readable storage medium including a set of instructions, that, when executed by one or more processors, cause a machine to:
create a vehicle token for a vehicle upon manufacture,
wherein the vehicle token includes a vehicle identification number and information relating to the vehicle,
wherein the owner of the vehicle token owns the vehicle;
in response to a purchase of the vehicle by a user, cryptographically transfer the vehicle token to the user in a first transaction;
receive, from sensors on the vehicle, a request for a second transaction, wherein the second transaction includes updating the information relating to the vehicle with information from the sensors; and
generate, based on the information relating to the vehicle, a valuation of the vehicle.

8. The non-transitory, computer-readable storage medium of claim 7, wherein the set of instructions, when executed by the one or more processors, further cause the machine to record the vehicle token, the first transaction, the second transaction, and the valuation to a distributed ledger.

9. The non-transitory, computer-readable storage medium of claim 7, wherein the set of instructions, when executed by the one or more processors, further cause the machine to:
receive, from an entity, a request for a third transaction relating to the vehicle, wherein the entity is a service provider servicing the vehicle; and
update the information relating to the vehicle with information from the service provider.

10. The non-transitory, computer-readable storage medium of claim 7, wherein the set of instructions, when executed by the one or more processors, further cause the machine to:
obtain information relating to the owner of the vehicle; and
associate the information relating to the owner of the vehicle with the vehicle token.

11. The non-transitory, computer-readable storage medium of claim 10, wherein the information relating to the owner of the vehicle is not publicly available.

12. The non-transitory, computer-readable storage medium of claim 7, wherein the set of instructions, when executed by the one or more processors, further cause the machine to create one or more fund tokens related to the vehicle token, wherein the one or more fund tokens are funded by an insurance company, wherein the one or more fund tokens pays service providers providing service to the vehicle.

13. A vehicle tracking and analysis system, comprising:
at least one processor;
at least one computer readable storage medium having instructions stored thereon, which when executed by the at least one processor causes the vehicle tracking and analysis system to:
create a vehicle token for a vehicle upon manufacture,
wherein the vehicle token includes a vehicle identification number and information relating to the vehicle,
wherein the owner of the vehicle token owns the vehicle;
in response to a purchase of the vehicle by a user, cryptographically transfer the vehicle token to the user in a first transaction;
receive, from sensors on the vehicle, a request for a second transaction, wherein the second transaction includes updating the information relating to the vehicle with information from the sensors; and
generate, based on the information relating to the vehicle, a valuation of the vehicle.

14. The vehicle tracking and analysis system of claim 13, wherein the instructions, when executed by the at least one processor, further cause the vehicle tracking and analysis system to record the vehicle token, the first transaction, the second transaction, and the valuation to a distributed ledger.

15. The vehicle tracking and analysis system of claim 13, wherein the instructions, when executed by the at least one processor, further cause the vehicle tracking and analysis system to:
receive, from an entity, a request for a third transaction relating to the vehicle, wherein the entity is a service provider servicing the vehicle; and
update the information relating to the vehicle with information from the service provider.

16. The vehicle tracking and analysis system of claim 13, wherein the instructions, when executed by the at least one processor, further cause the vehicle tracking and analysis system to:
obtain information relating to the owner of the vehicle; and
associate the information relating to the owner of the vehicle with the vehicle token.

17. The vehicle tracking and analysis system of claim 16, wherein the information relating to the owner of the vehicle is not publicly available.

18. The vehicle tracking and analysis system of claim 13, wherein the instructions, when executed by the at least one processor, further cause the vehicle tracking and analysis system to create one or more fund tokens related to the vehicle token, wherein the one or more fund tokens are funded by an insurance company, wherein the one or more fund tokens pays service providers providing service to the vehicle.
